(19) United States
(12) Patent Application Publication
(10) Pub. No.: US 2018/0346022 A1
(43) Pub. Date: Dec. 6, 2018

(54) STEERING SYSTEM FOR AN INDUSTRIAL VEHICLE

(71) Applicant: 6777856 CANADA INC., Sherbrooke (CA)

(72) Inventor: Louis PAYEUR, Sherbrooke (CA)

(21) Appl. No.: 15/992,866

(22) Filed: May 30, 2018

Related U.S. Application Data
(60) Provisional application No. 62/514,241, filed on Jun. 2, 2017.

(51) Int. Cl. B62D 7/16; B62D 7/09; B62D 7/20; B62D 3/02

(52) U.S. Cl. CPC B62D 7/163; B62D 3/02; B62D 7/20; B62D 7/09

(57) ABSTRACT

A stand-up type industrial vehicle, such as a stock chaser, is provided that includes a frame including a driver's space, a pair of steerable front wheels, and a steering system. The frame can include a cargo space behind the driver's space. The front wheels are pivotally coupled to the frame about respective laterally spaced-apart steering axes. The steering system is mounted to the frame for steering the wheels. The steering system includes a steering wheel, a steering lever operatively coupled to the steering wheel, for example via an upper and a lower shaft coupled by a one-stage reducer assembly, to be imparted a lateral swinging motion thereby upon rotation thereof, and a steering linkage coupled between the steering lever and the wheels to translate this lateral swinging motion into a turning motion of the wheels. A dual-pivot steering system for use in a stand-up type industrial vehicle is also provided.

### CROSS-REFERENCE TO RELATED APPLICATIONS

This application claims priority under 35 U.S.C. § 119(e) of U.S. provisional patent application 62/514,241 filed on Jun. 2, 2017, the specification of which is hereby incorporated by reference

### TECHNICAL FIELD

The technical field generally relates to industrial vehicles for indoor material and products handling, such as stock chasers and other stand-up type industrial vehicles. More particularly, the technical field relates to a steering system for use in such vehicles.

### BACKGROUND

Conventional industrial vehicles, such as the stock chaser 200 shown in FIGS. 1A and 1B (PRIOR ART), are known in the art. Conventional stock chasers are a stand-up type, electrically powered industrial vehicles that typically include a rear driving platform, a vertical steering wheel, a steering system, a relatively narrow body, a rear ladder, and a front cargo deck (e.g., with a typical 1000-lbs cargo capacity). Such stock chasers have remained more or less unchanged for the last twenty years despite numerous challenges, limitations and problems associated with their use. Such challenges include poor ergonomics, which are sometimes associated with, for example, back pain problems, and/or poor stability, which may be associated with tip-over hazards.

Conventional stock chasers generally include a multi-stage reducer steering mechanism (e.g., a two-stage steering mechanisms), which is, amongst other limitations, hardly adjustable for backlash. Conventional stock chasers also generally include a single-pivot steering system, which often suffers from poor lateral stability, hence resulting in safety and tip-over hazards. The conventional stock chaser 200 illustrated in FIGS. 1A and 1B (PRIOR ART) incorporate both a two-stage reducer steering mechanism and a single-pivot steering mechanism, and hence suffers from both types of limitations recited above.

Stock chasers are however appreciated in the art as a low-cost solution for indoor material and product handling. Accordingly, in addition to the abovementioned factors, manufacturing cost should be considered when designing and/or producing stock chasers.

In view of the foregoing, there is still a need for a stand-up type industrial vehicle that overcomes or at least alleviates some of the abovementioned challenges and limitations.

### SUMMARY

The present description generally relates to stand-up type industrial vehicles having a dual-pivot steering system, that is, a steering system having two off-centered steering pivots, and to a dual-pivot steering system for use such vehicles.

In accordance with one aspect, there is provided a steering system for use in a stand-up type industrial vehicle having a pair of steerable front wheels. Each steerable front wheel is pivotable about a respective one of a pair of steering axes. The steering system includes a reducer steering system and a steering linkage. The reducer steering mechanism includes a rotatable steering wheel, an upper steering shaft, a lower steering shaft, a reducer assembly and a steering lever. The upper steering shaft is rotatable about an upper shaft axis by the steering wheel. The lower steering shaft is coupled to the upper steering shaft and rotatable therewith about a lower shaft axis. The reducer assembly is coupled between the upper steering shaft and the lower steering shaft to rotate the lower steering shaft upon rotation of the upper steering shaft. The steering lever extends outwardly from the lower steering shaft and effects a swinging motion about the lower shaft axis upon rotation of the lower steering shaft. The steering linkage is operatively connected between the steering lever and the steerable wheels. The steering linkage is configured to translate the swinging motion of the steering lever into a turning motion of the steerable front wheels about the steering axes thereof.

In some embodiments, the pair of steerable front wheels defines a leading wheel and a trailing wheel, and the steering linkage includes a pair of pivot arms defining a leading pivot arm coupled to the leading wheel and pivotable therewith about the steering axis thereof, and a trailing pivot arm coupled to the trailing wheel and pivotable therewith about the steering axis thereof; a tie rod pivotally coupled between the steering lever and the leading pivot arm, the tie rod being laterally movable by the swinging motion of the steering lever to turn, via the leading pivot arm, the leading wheel about the steering axis thereof; and a track rod pivotally coupled between the leading pivot arm and the trailing pivot arm to cause the trailing wheel to turn about the steering axis thereof upon turning of the leading wheel.

In some embodiments, the tie rod is secured to the leading pivot arm at a first location thereof, and the track rod is secured to the leading pivot arm at a second location thereof, the second location being farther remote from the steering axis of the leading wheel than is the first location.

In some embodiments, the tie rod is secured to the leading pivot arm at a first location thereof and the track rod is secured to the leading pivot arm at a second location thereof, the first location and the second location being located on either side of the steering axis of the leading wheel.

In some embodiments, the steering linkage includes a pair of pivot arms, each pivot arm being coupled to a respective one of the pair of steerable front wheels and pivotable therewith about the steering axis thereof; and a pair of tie rods, each tie rod being pivotally coupled between the steering lever and a respective one of the pair of pivot arms, and laterally movable by the swinging motion of the steering lever to turn, via the respective pivot arm, the respective steerable front wheel about the corresponding steering axis thereof.

In some embodiments, each pivot arm has an effective pivoting radius about the steering axis of the respective steerable front wheel, the effective pivoting radius being substantially equal to an effective swinging radius associated with the swinging motion of the steering lever about the lower shaft axis.

In some embodiments, the reducer assembly is a one-stage reducer assembly including an upper sprocket mounted to the upper steering shaft and rotatable therewith about the upper steering shaft axis; a lower sprocket mounted to the lower steering shaft and rotatable therewith about the lower steering shaft axis; and a drive chain engaging and interconnecting the upper sprocket and the lower sprocket to transmit, in one stage, the rotation of the upper steering shaft to the lower steering shaft.

In some embodiments, the reducer assembly has a gearing ratio, the gearing ratio being determined by a ratio of a number of teeth of the lower sprocket to a number of teeth of the upper sprocket.

In some embodiments, the gearing ratio ranges between about 1:1 and about 10:1.

In some embodiments, the gearing ratio is 6:1.

In some embodiments, the reducer steering mechanism is centrally positioned between the steering axes of the steerable front wheels.

In some embodiments, the steering wheel is tilted forwardly and downwardly at a tilt angle ranging from about 0° to about 15° with respect to a vertical axis.

In accordance with another aspect, there is provided a stand-up type industrial vehicle. The vehicle includes a frame, a pair of steerable front wheels and a steering system. The frame extends between a front end and a rear end and includes a driver's space for accommodating an operator. The pair of steerable front wheels is coupled to the frame, and each steerable front wheel is pivotable relative to the frame about a respective one of a pair of laterally spaced-apart steering axes. The steering system is mounted to the frame for steering the pair of steerable front wheels and includes a reducer steering mechanism and a steering linkage. The reducer steering mechanism includes a steering wheel, an upper steering shaft, a lower steering shaft, a reducer assembly and a steering lever. The steering wheel is rotatable by the operator. The upper steering shaft is rotatable about an upper shaft axis by the steering wheel. The lower steering shaft is coupled to the upper steering shaft and is rotatable therewith about a lower shaft axis. The reducer assembly is coupled between the upper steering shaft and the lower steering shaft to rotate the lower steering shaft upon rotation of the upper steering shaft. The steering lever extends outwardly from the lower steering shaft and effects a swinging motion about the lower shaft axis upon rotation of the lower steering shaft. The steering linkage is operatively connected between the steering lever and the steerable front wheels. The steering linkage is configured to translate the swinging motion of the steering lever into a turning motion of the steerable front wheels about the steering axes thereof.

In some embodiments, the industrial vehicle further includes a pair of rear wheels coupled to the frame; a front axle mounted transversally to the frame and supporting the pair of steerable front wheels; and a rear axle mounted transversally to the frame and supporting the pair of rear wheels. The driver's space is provided between the front axle and the rear axle.

In some embodiments, the industrial vehicle further includes a cargo space extending rearwardly of the driver's space.

In some embodiments, the cargo space has a loading surface area ranging between about 1200 and about 1800 square inches.

In some embodiments, the industrial vehicle further includes a ladder extending upwardly and rearwardly between a lower end mounted to the frame, adjacent to and behind the driver's space, and an upper end.

In some embodiments, the lower end of the ladder is mounted to the frame at substantially a midpoint between the front end and the rear end of the frame.

In some embodiments, the ladder includes between one and five rungs.

In some embodiments, the industrial vehicle further includes a cantilever platform extending rearwardly from the upper end of the ladder and configured for the operator to stand thereon.

In some embodiments, the cantilever platform has a platform surface area ranging from about 200 square inches to about 500 square inches.

In some embodiments, the cantilever platform is positioned at a working height of about 48 inches above ground.

In some embodiments, the cantilever platform includes a guard rail extending upwardly along a perimeter thereof, the guard rail having a front opening to allow access between the cantilever platform and the ladder.

In some embodiments, the ladder is inclined at an inclination angle ranging between about 8° and about 15° with respect to a vertical axis.

In some embodiments, the ladder has a lateral extent ranging from about 25 inches to about 35 inches.

In some embodiments, the lateral extent of the ladder is substantially equal to a lateral extent of the frame.

In some embodiments, the industrial vehicle further includes a front-loading space located forwardly of the driver's space.

In some embodiments, the pair of steerable front wheels defines a leading wheel and a trailing wheel, and the steering linkage includes a pair of pivot arms defining a leading pivot arm coupled to the leading wheel and pivotable therewith about the steering axis thereof, and a trailing pivot arm coupled to the trailing wheel and pivotable therewith about the steering axis thereof; a tie rod pivotally coupled between the steering lever and the leading pivot arm, the tie rod being laterally movable by the swinging motion of the steering lever to turn, via the leading pivot arm, the leading wheel about the steering axis thereof; and a track rod pivotally coupled between the leading pivot arm and the trailing pivot arm to cause the trailing wheel to turn about the steering axis thereof upon turning of the leading wheel.

In some embodiments, the tie rod is secured to the leading pivot arm at a first location thereof, and the track rod is secured to the leading pivot arm at a second location thereof, the second location being farther remote from the steering axis of the leading wheel than is the first location.

In some embodiments, the tie rod is secured to the leading pivot arm at a first location thereof and the track rod is secured to the leading pivot arm at a second location thereof, the first location and the second location being located on either side of the steering axis of the leading wheel.

In some embodiments, the steering linkage includes a pair of pivot arms, each pivot arm being coupled to a respective one of the pair of steerable front wheels and pivotable therewith about the steering axis thereof; and a pair of tie rods, each tie rod being pivotally coupled between the steering lever and a respective one of the pair of pivot arms, and laterally movable by the swinging motion of the steering lever to turn, via the respective pivot arm, the respective steerable front wheel about the corresponding steering axis thereof.

In some embodiments, each pivot arm has an effective pivoting radius about the steering axis of the respective steerable front wheel, the effective pivoting radius being substantially equal to an effective swinging radius associated with the swinging motion of the steering lever about the lower shaft axis.

In some embodiments, the reducer assembly includes an upper sprocket mounted to the upper steering shaft and rotatable therewith about the upper steering shaft axis; a lower sprocket mounted to the lower steering shaft and rotatable therewith about the lower steering shaft axis; and a drive chain engaging and interconnecting the upper sprocket and the lower sprocket to transmit the rotation of the upper steering shaft to the lower steering shaft.

In some embodiments, the reducer assembly has a gearing ratio, the gearing ratio being determined by a ratio of a number of teeth of the lower sprocket to a number of teeth of the upper sprocket.

In some embodiments, the gearing ratio ranges between 1:1 and 10:1.

In some embodiments, the gearing ratio is 6:1.

In some embodiments, the reducer steering mechanism is centrally positioned between the steering axes of the steerable front wheels.

In some embodiments, the steering wheel is tilted forwardly and downwardly at a tilt angle ranging from about 0° to about 15°.

In some embodiments, the industrial vehicle is a stock chaser.

In accordance with another aspect, there is provided a stand-up type industrial vehicle. The stand-up type industrial vehicle includes a frame, a pair of steerable front wheels and a steering system. The frame extends between a front end and a rear end and includes a driver's space for accommodating an operator and a cargo space behind the driver's space. The pair of steerable front wheels is pivotally coupled to the frame about a respective pair of laterally spaced-apart steering axes. The steering system is mounted to the frame for steering the pair of steerable front wheels. The steering system includes a steering wheel rotatable by the operator, a steering lever operatively coupled to the steering wheel to be imparted a lateral swinging motion thereby upon rotation thereof and a steering linkage operatively coupled between the steering lever and the steerable front wheels to translate the lateral swinging motion of the steering lever into a turning motion of the steerable front wheels about the steering axes thereof.

In some embodiments, the industrial vehicle further includes a one-stage reducer interconnecting the steering wheel and the steering level.

In some embodiments, the industrial vehicle further includes a pair of rear wheels coupled to the frame, the driver's area extending between the front wheels and the rear wheels.

In some embodiments, the industrial vehicle further includes a ladder extending upwardly and rearwardly between a lower end mounted to the frame, adjacent to and behind the driver's space, and an upper end.

In some embodiments, the industrial vehicle further includes a cantilever platform extending rearwardly from the upper end of the ladder above the cargo area.

In some embodiments, the ladder is inclined at an inclination angle ranging between about 8° and about 15° with respect to a vertical axis.

In some implementations, there is provided a steering system that includes a one-stage reducer steering mechanism for steering a pair of steerable wheels of a stock chaser or a similar vehicle about a pair of distinct pivot points (dual-pivot steering system). The one-stage reducer steering mechanism can include a steering wheel, an upper steering shaft connected to and rotatable with the steering wheel, and a lower steering shaft connected to the upper steering shaft. The one-stage reducer steering mechanism can also include a Pitman arm, acting as a steering lever, connected to the lower steering shaft and including a proximal end and a distal end. The steering system can also include a Pitman tie rod, a track rod, a pair of pivot arms, and a pair of steering pivots associated with the pair of pivot arms. The lower steering shaft is connected to the proximal end of the Pitman arm. The distal end of the Pitman arm is connected to one of the two pivot arms through the Pitman tie rod. The track rod connects the pivot arms together. Each one of the two pivot arms is, in turn, pivotally connected to a respective one of the steerable wheels via the associated steering pivot.

In operation, a rotational motion imparted to the steering wheel is transferred to the Pitman arm successively via the upper steering shaft, the one-stage reducer steering mechanism, and the lower steering shaft. The rotational motion of the Pitman arm is converted into a linear motion of the Pitman tie rod which acts to steer the wheel to which it is connected (i.e., the leading wheel) around the associated steering pivot. The other wheel (i.e., the trailing wheel) is also steered due to its connection to the leading wheel via the track rod.

In some implementations, there is provided a steering system that includes a one-stage reducer steering mechanism for steering a pair of steerable wheels of a stock chaser or a similar vehicle about a pair of distinct pivot points (dual-pivot steering system). The one-stage reducer steering mechanism can include a steering wheel, an upper steering shaft connected to and rotatable with the steering wheel, and a lower steering shaft connected to the upper steering shaft. The one-stage reducer steering mechanism can also include a Pitman arm, acting as a steering lever, connected to the lower steering shaft and including a proximal end and a distal end. The steering system can also include a pair of Pitman tie rods, a pair of pivot arms, and a pair of steering pivots associated with the pair of pivot arms. The lower steering shaft is connected to the proximal end of the Pitman arm. The distal end of the Pitman arm is connected to each one of the pair of pivot arms through a respective one of the pair of Pitman tie rods. Each one of the two pivot arms is pivotally connected to a respective one of the steerable wheels via the associated steering pivot.

In one embodiment, the one-stage reducer steering mechanism includes an upper sprocket, a lower sprocket, a drive chain connecting the upper sprocket to the lower sprocket, and a Pitman arm. The upper sprocket is connected to the upper steering shaft, the lower sprocket is connected to the lower steering shaft, and the Pitman arm is connected to the lower steering shaft.

In some implementations, there is provided a stock chaser. The stock chaser can include a frame having a front end and a rear end, and a pair of steering pivots mounted at or near the front end of the frame. The stock chaser can also include a one-stage reducer steering mechanism as described herein.

In one embodiment, the one-stage reducer steering mechanism is part of a dual-pivot steering system, with a left pivot to steer a left wheel and a right pivot to steer a right wheel.

In one embodiment, the stock chaser includes a driver platform located near the front end of the frame. Alternatively, the driver platform can be provided in a central portion of the frame (i.e., at or near a midpoint between the front end and the rear end) or even closer to the rear end of the frame.

In one embodiment, the stock chaser includes a cargo deck for supporting and handling the products. In one embodiment, the cargo deck is located near the rear end of the frame. For example, the cargo deck can extend from the driver platform to the rear end. Alternatively, the cargo deck can be located near the front end of the frame (in front of the driver platform), or can have two or more sections (i.e., one section near the front end of the frame, and one section near the rear end of the frame).

In one embodiment, the stock chaser is electrically powered.

In one embodiment, the stock chaser includes a ladder mounted onto the frame and extending upwardly therefrom. Alternatively, the stock chaser can include a structural member mounted onto the frame and onto which can be mounted a ladder.

In one embodiment, the stock chaser includes a backrest cushion mounted on the ladder. Alternatively, the ladder may be replaced by a structural member, or a bulkhead, on which can be mounted a backrest cushion and/or a ladder.

Some embodiments of the stand-up type industrial vehicle disclosed herein offers at least one of the following benefits:
1. A dual-pivot steering system to solve and at least reduce or mitigate the stability problems associated with conventional stand-up type industrial vehicles.
2. A driving platform provided closer to the front wheel than to the rear wheels. Such driving platform does not increase tip-over hazards, to reduce back pain problems and enable a more ergonomic stand straight driving position.
3. A one-stage reducer steering mechanism that may be fitted with a vertical or inclined steering wheel, and that can reduce the angle of rotation to facilitate steering control and convert the angular motion into a linear motion to steer the steering pivots, all in a single mechanism. Such a one-stage reducer steering mechanism is different from conventional steering mechanisms. For example, known in the art are light duty vehicles with a steering shaft on which is mounted a steering wheel at one end and a steering lever (Pitman arm) at the other end to steer the steering pivots. Such a steering system would be very hard to steer on a heavier duty vehicle such as a stand-up type industrial vehicle or a stock chaser, since there is no reducer mechanism, and the steering wheel would have to be mounted horizontally above the steering pivots. Also known in the art are automotive steering gearboxes with a steering wheel connected at the input, and a Pitman arm or tie rods connected to the output. Such a system would need another mechanism, such as bevel gears, to mount the steering wheel vertically above the steering pivots, and would be more expensive to make and harder to adjust for backlash.

Other features and aspects of the invention will be better understood upon reading of embodiments thereof with reference to the appended drawings.

### BRIEF DESCRIPTION OF THE DRAWINGS

FIGS. 1A-B (PRIOR ART) respectively show a side elevation view of a conventional industrial vehicle and a top plan view of the conventional industrial vehicle.

FIGS. 2A-B respectively illustrate a side elevation view and a top plan view of a stand-up type industrial vehicle having a dual-pivot steering system including a reducer steering mechanism and a steering linkage, according to one exemplary embodiment.

FIGS. 3A-C each illustrate a perspective view of the steering system of the stand-up type industrial vehicle of FIG. 2A-B, in operation.

FIG. 4 is a side view the reducer steering mechanism of the steering system of FIG. 3.

FIGS. 5A-B are respectively a rear elevation view and a top plan view of part of the steering system of FIG. 3. In FIG. 5B, the steering wheel, the upper steering shaft and the reducer assembly are omitted, for clarity.

FIGS. 6A-B are respectively a rear elevation view and a top plan view of part of another exemplary embodiment of a steering system for use in a stand-up type industrial vehicle. In FIG. 6B, the steering wheel, the upper steering shaft and the reducer assembly are omitted, for clarity.

FIGS. 7A-B are respectively a rear elevation view and a top plan view of part of another exemplary embodiment of a steering system for use in a stand-up type industrial vehicle. In FIG. 7B, the steering wheel, the upper steering shaft and the reducer assembly are omitted, for clarity.

FIG. 8 is a partially exploded view of part of a steering linkage of a steering system coupled to a leading wheel, in accordance with one embodiment.

FIG. 9 is another partially exploded view of part of the steering linkage shown in FIG. 8.

FIG. 10 is another partially exploded view of part of the steering linkage shown in FIG. 8.

FIG. 11 illustrates a side elevation view of a stand-up type industrial vehicle having a dual-pivot steering system, according to another exemplary embodiment.

### DETAILED DESCRIPTION

In the following description, similar features in the drawings have been given similar reference numerals, and, to not unduly encumber the figures, some elements may not be indicated on some figures if they were already identified in one or more preceding figures. It should also be understood herein that the elements of the drawings are not necessarily depicted to scale, since emphasis is placed upon clearly illustrating the elements and structures of the present embodiments.

In the following description, and unless stated otherwise, the terms “connected”, “coupled”, and “engaged”, and variants and derivatives thereof, refer to any connection, coupling or engagement, either direct or indirect, between two or more elements. The connection, coupling or engagement between the elements may be mechanical, physical, operational, electrical or a combination thereof.

The terms “a”, “an” and “one” are defined herein to mean “at least one”, that is, these terms do not exclude a plural number of elements, unless stated otherwise. It should also be noted that terms such as “substantially”, “generally” and “about”, that modify a value, condition or characteristic of a feature of an exemplary embodiment, should be understood to mean that the value, condition or characteristic is defined within tolerances that are acceptable for the proper operation of this exemplary embodiment for its intended

It will be appreciated that positional descriptors indicating the position or orientation of one element with respect to another element are used herein for ease and clarity of description and should, unless otherwise indicated, be taken in the context of the figures and should not be considered limiting. It will be understood that spatially relative terms (e.g., “top” and “bottom”, “left” and “right”, “front” and “rear”, “upward” and “downward”, “adjacent” and “opposite”, and “vertical” and “horizontal”) are intended to encompass different positions and orientations in use or operation of the present embodiments, in addition to the positions and orientations exemplified in the figures.

In the current description, the expression “stand-up type industrial vehicle” is intended to encompass not only stock chaser but also any other type of compact stand-up type vehicles provided with a steering wheel and a reducer assembly and used for transporting objects, products or items, for example and without being limitative, in a warehouse. The stand-up type industrial vehicles described herein may, but need not, be powered electrically.

### Overview of Limitations of Conventional Stock Chasers

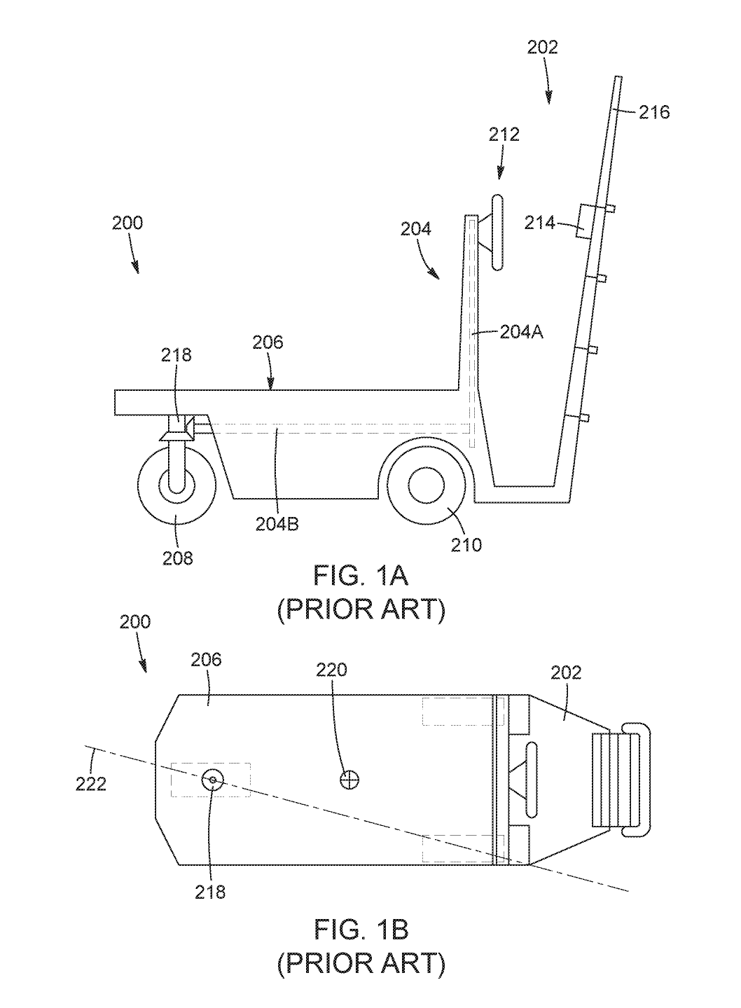

Referring to FIG. 1A (PRIOR ART), a profile view of a conventional stand-up type industrial vehicle 200 is shown. Such conventional industrial vehicle 200 generally includes, a rear driving platform 202, a two-stage reducer steering mechanism 204, a cargo deck 206, a pair of front wheels 208 and a pair of rear wheels 210.

As illustrated in FIG. 1A, the driving platform 202 is located in a rear portion of the industrial vehicle 200 in a “cantilever configuration”, i.e., the driver platform 202 protrudes rearwardly from the frame of the industrial vehicle 200, behind the rear wheels 210. The rear driving platform 202 is configured to accommodate an operator in a standing position for operating the industrial vehicle 200. The conventional industrial vehicle 200 also includes a vertical steering wheel 212, and an inclined user's back support 214 on which is bolted a steep-angle ladder 216.

The two-stage reducer steering mechanism 204 can include a first-stage steering mechanism 204A and a second-stage steering mechanism 204B coupled with the first-stage steering mechanism 204A with bevel gears or the like. Such a multi-stage reducer steering mechanism 204 can be troublesome to adjust for backlash.

The vertical steering wheel 212 engages with the two-stage reducer steering mechanism 204 to steer the front wheels 208 about a single steering pivot 218 of the industrial vehicle 200. The vertical steering wheel 212 is typically mounted at approximately two-thirds of the operator height.

The expression “single-pivot steering” herein refers to a steering system in which the front axle is pivoted at single point. Such single-pivot steering system allows steering the industrial vehicle 200 at sharp angle, i.e., it enables a short turning radius, which might be useful, for example, in setting or area with restricted space, but is also associated with tip-over risk, as explained below.

FIG. 1B shows a top plan view of the conventional industrial vehicle 200 of FIG. 1A. FIG. 1B illustrates the single steering pivot 218, as well as the typical locations of the center of gravity 220, as well as the tip-over axis 222 of conventional industrial vehicle 200. One of the challenges associated with conventional single-pivot-steering stock chasers is that they suffer from poor lateral stability and increased tip-over hazards, because their center of gravity 220 is close to the tip-over axis 222, which is associated with a tip-over risk.

One strategy to overcome the above-mentioned challenge is to have the weight of conventional industrial vehicle 200 distributed more toward the rear end of the vehicle (e.g., at or beyond the rear axle). However, this approach is associated with numerous challenges and drawbacks in terms of ergonomics, such as, but not limited to:
1. Back pain problems, which are typically caused by the rear driving platform 202 being mounted in the cantilever configuration. Such configuration amplifies vibrations generated by floor imperfections;
2. The fact that the operator must stand inclined toward the rear end of the industrial vehicle 200, with his or her back pressed against the inclined backrest 214, to reduce the cantilever span and improve longitudinal stability; and/or
3. Fatigue problems associated with the steep ladder 216 that is hard to climb while holding stock or products to handle. Such steep ladders are typically used so as to be less detrimental to the longitudinal stability of the stock chaser.
   Industrial Vehicle with Dual-Pivot Steering System

The present description generally relates to a stand-up type industrial vehicle including a dual-pivot steering system, rather than a single steering pivot such as in the above-described conventional industrial vehicles. The present description also generally relates to a dual-pivot steering system for use in a stand-up type industrial vehicle. The embodiments described below may be useful in resolving or at least reducing some of the above-mentioned problems associated with conventional stand-up type industrial vehicles.

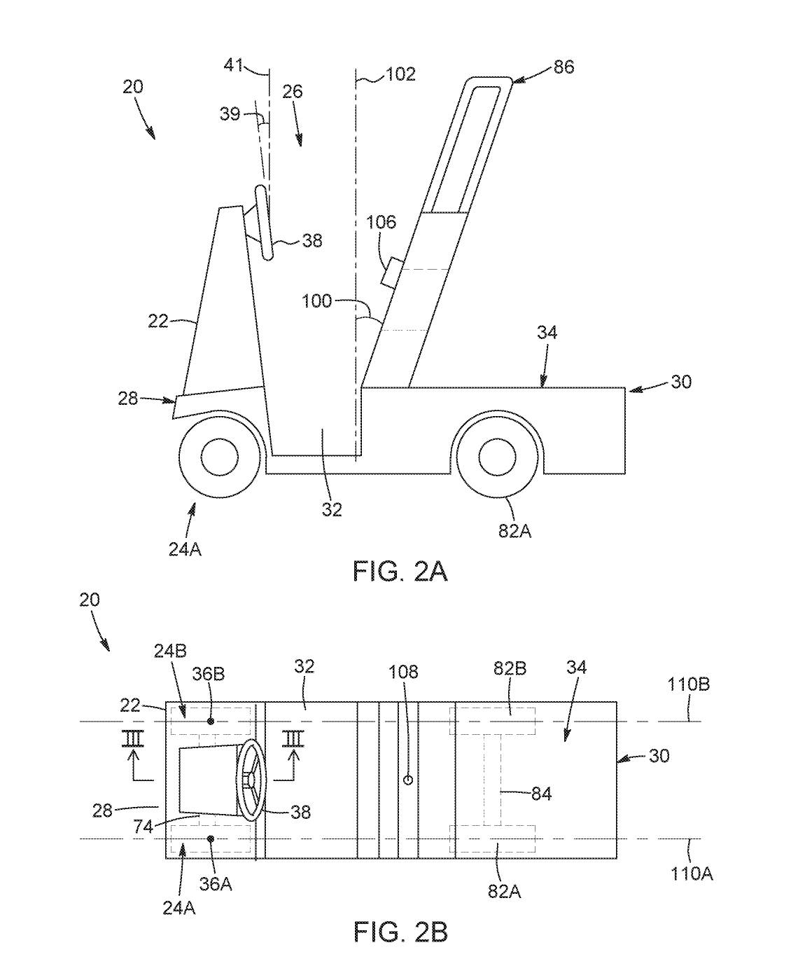

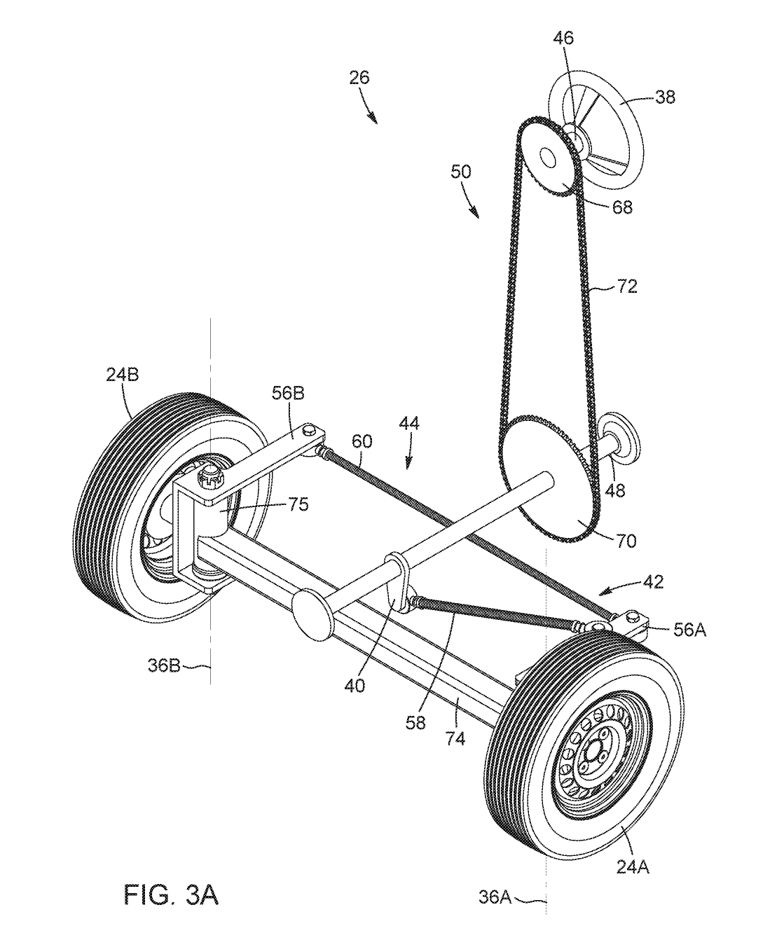

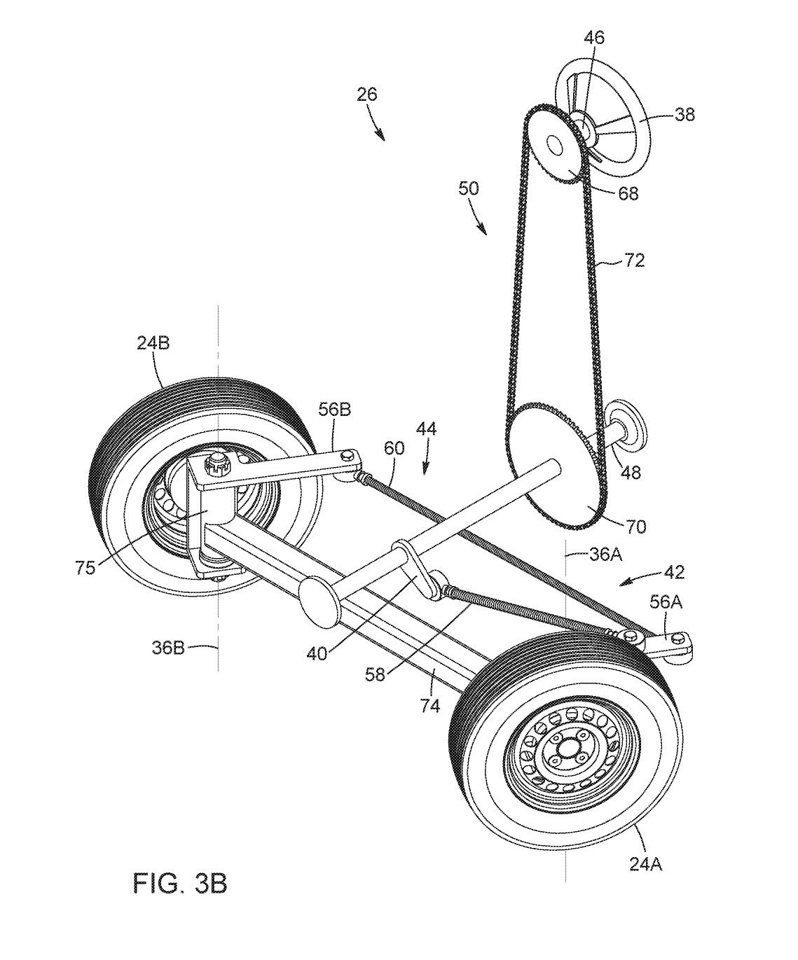

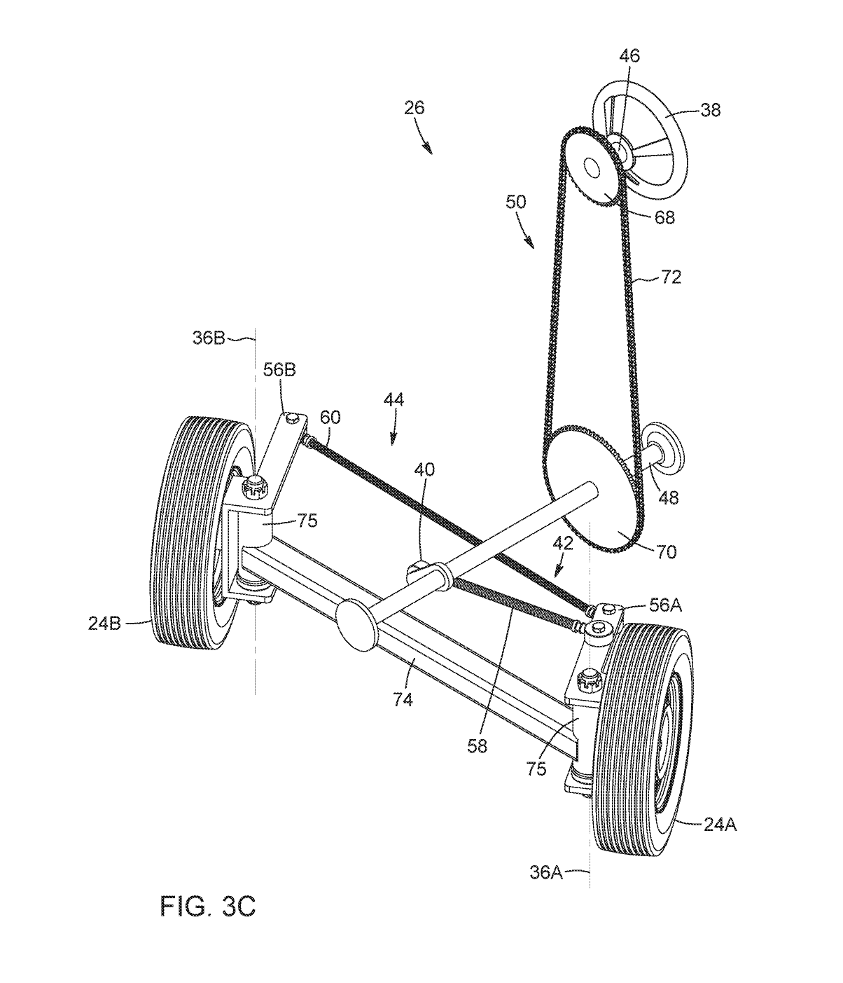

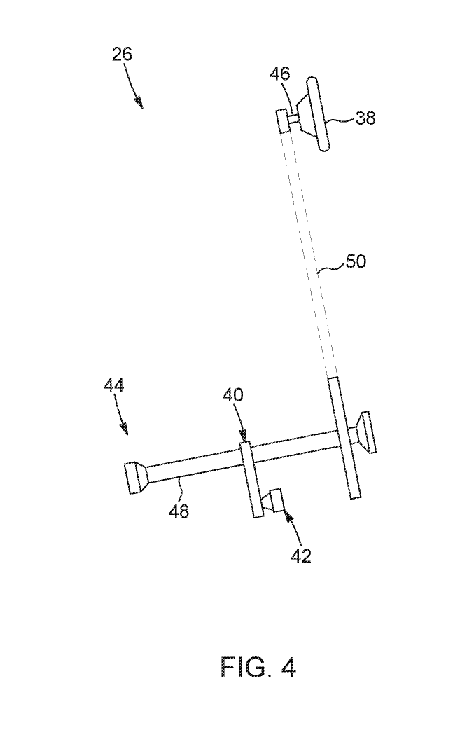

Referring to FIGS. 2A-B, an embodiment of a stand-up type industrial vehicle 20 includes is shown. The industrial vehicle 20 generally includes a frame 22, a pair of steerable front wheels 24A,B and a steering system 26 (see also in FIGS. 3, 4 and 5A-B). The frame 22 extends between a front end 28 and a rear end 30. The frame 22 includes a driver's space 32 for accommodating an operator and a cargo space 34 behind the driver's space 32. Each of the steerable front wheels 24A,B is pivotally coupled to the frame 22 about a respective one of a pair of laterally spaced-apart steering axes 36A,B. The steering system 26 is mounted to the frame 22 for steering the pair of steerable front wheels 24A,B.

With reference to FIG. 3, the steering system 26 includes a steering wheel 38 rotatable by the operator, a steering lever 40 operatively coupled to the steering wheel 38 to be imparted a lateral swinging motion thereby upon rotation thereof. The steering system 26 also includes a steering linkage 42 operatively coupled between the steering lever 40 and the steerable front wheels 24A,B to translate the lateral swinging motion of the steering lever 40 into a turning motion of the steerable front wheels 24A,B about the steering axes 36A,B thereof.

The structure, configuration and operation of these and other components of the industrial vehicle 20 will be described in greater detail below, starting with the steering system 26.

### Steering System

Referring to FIGS. 3, 4 and 5A-B, various aspects of the steering system 26 of the industrial vehicle 20 of FIGS. 2A-B will now be described. The steering system 26 of FIGS. 3, 4 and 5A-B can be used not only with the industrial vehicle of FIGS. 2A-B, but also with various other types of stand-up type industrial vehicles having a pair of steerable front wheels.

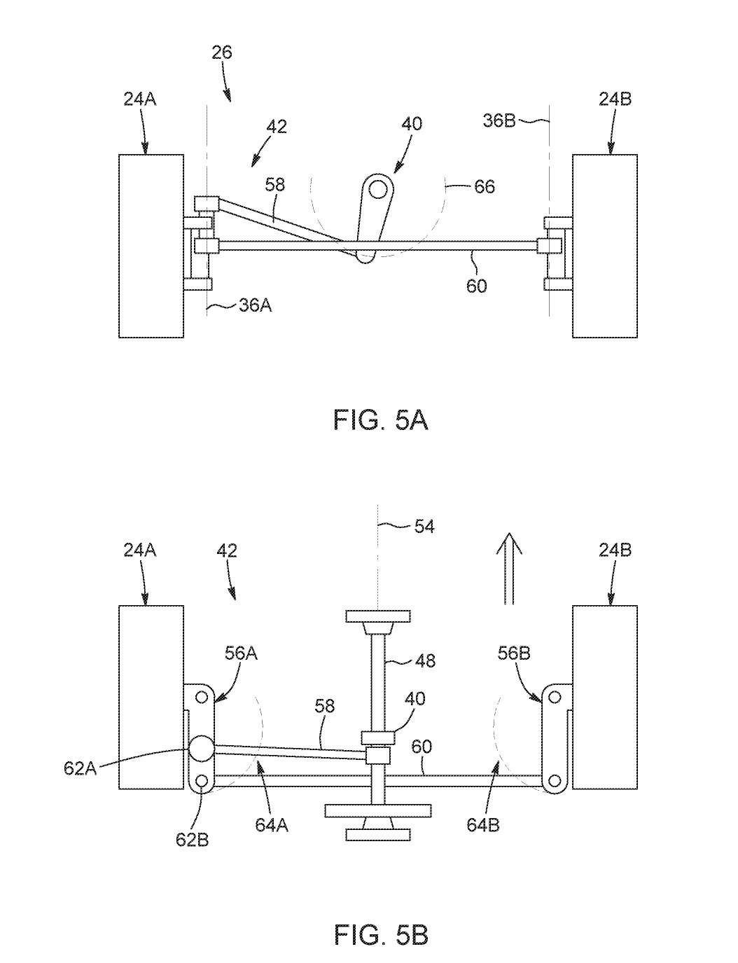

In the illustrated embodiment, the steering system 26 generally includes a reducer steering mechanism 44 and a steering linkage 42. These and other components of the steering system 26 are described in greater below. It is noted that the upwardly directed arrow in FIGS. 5A-5B defines the forward moving direction of the industrial vehicle provided with the steering system 26.

The reducer steering mechanism 44 includes a rotatable steering wheel 38, an upper steering shaft 46, a lower steering shaft 48, a reducer assembly 50 and a steering lever 40.

The steering wheel 38 is rotatable by the operator of the industrial vehicle 20. The steering wheel 38 can be embodied by an assembly of different parts and/or components and is as such configured to be manipulated by the operator, i.e., to enable the operator to provide the reducer steering mechanism 44 with driver's input, hence allowing the operator to act upon the reducer steering mechanism 44.

In the illustrated embodiment of FIG. 2A, the steering wheel 38 is tilted forwardly and downwardly at a tilt angle 39 with respect to a vertical axis 41. The tilt angle 39 can range, for example and without being limitative from about 0° to about 15° with respect to the vertical axis 41 of the industrial vehicle 20. In alternate embodiments, the steering wheel 38 is vertical and could for example be mounted close to the operator in the driver's space 32 to provide effective holding in turns. When inclined, the steering wheel 38 may be more ergonomic for the user when standing up in a driving position in the driver's space 32.

Turning back to FIGS. 3, 4 and 5A-5B, the upper steering shaft 46 is rotatable about an upper shaft axis 52 by the steering wheel 38 which, in the illustrated embodiment, coincides with the steering wheel rotation axis. More particularly, the steering wheel 38 is connected to the upper steering shaft 46 at (or near) the upper end thereof (i.e., the end proximate the operator). Because of the mechanical connection between the steering wheel 38 and the upper steering shaft 46, a rotational movement of the steering wheel 38 is transferred to the upper steering shaft 46. For example, the steering wheel 38 could be mechanically rigidly connected to the upper steering shaft 46, so that the rotational movement of the steering wheel 38 is directly imparted to the upper steering shaft 46. Of course, one or more intermediary parts and/or components may be provided between the steering wheel 38 and the upper steering shaft 46, for example to enable a more efficient transfer of the rotational movement of the steering wheel 38 to the upper steering shaft 46.

The lower steering shaft 48 is coupled to the upper steering shaft 46 and rotatable therewith about a lower shaft axis 54. The coupling between the upper steering shaft 46 and the lower steering shaft 48 is provided by the reducer assembly 50, which allows the lower steering shaft 48 to rotate upon rotation of the upper steering shaft 46. As it will be described later in the description, the reducer assembly can be embodied by different parts and/or components which enable a rotational movement of the upper steering shaft 46 to be imparted to the lower steering shaft 48 when the upper steering shaft 46 is rotated by the steering wheel 38.

The steering lever 40 extends outwardly from the lower steering shaft 48. The steering lever 40 effects a swinging motion about the lower shaft axis 54 of the lower steering shaft 48 upon rotation of the lower steering shaft 48.

The steering linkage 42 is operatively connected between the steering lever 40 and the steerable wheels 24A,B. The steering linkage 42 is configured to translate the swinging motion of the steering lever 40 into a turning motion of the steerable front wheels 24A,B about the steering axes 36A,B thereof, as it will be described in greater detail below.

Referring now more specifically to FIGS. 5A-B, the steering linkage 42 and its connection to the reducer steering mechanism 44 are illustrated in greater detail.

In this first embodiment of the steering system 26, the pair of steerable front wheels 24A,B defines a leading wheel 24A and a trailing wheel 24B, and the steering linkage 42 includes a pair of pivot arms 56A,B, a tie rod 58, and a track rod 60.

The pair of pivot arms 56A,B defines a leading pivot arm 56A coupled to the leading wheel 24A, and pivotable therewith about the steering axis 36A thereof, and a trailing pivot arm 56B coupled to the trailing wheel 24B, and pivotable therewith about the steering axis 36B thereof.

The tie rod 58 is pivotally coupled between the steering lever 40 and the leading pivot arm 56A. The tie rod 58 is laterally movable by the swinging motion of the steering lever 40 about the lower shaft axis 54 to turn, via the leading pivot arm 56A, the leading wheel 24A about its steering axis 36A.

The track rod 60 is pivotally coupled between the leading pivot arm 56A and the trailing pivot arm 56B to cause the trailing wheel 24B to turn about the steering axis 36B upon turning of the leading wheel 24A.

In some embodiments, the tie rod 58 is secured to the leading pivot arm 56A (which is associated with the leading wheel 24A) at a first location 62A, and the track rod 60 is secured to the leading pivot arm 56A at a second location 62B. As illustrated in FIG. 5B, the second location 62B is farther remote from the steering axis 36A of the leading wheel 24A than is the first location 62A, i.e., that the first location 62A is comprised between the steering axis 36A and the second location 62B. In the illustrated embodiment, both the first location 62A and the second location 62B are located behind the steering axis 36A of the leading wheel 24 with respect to the forward moving direction.

It is to be noted that each pivot arm 56A,B has a corresponding effective pivoting radius 64A,B about the respective steering axis 36A,B of the respective steerable front wheel 24A,B. In some embodiments, the effective pivoting radii 64A,B are substantially equal to an effective swinging radius 66 associated with the swinging motion of the steering lever 40 about the lower shaft axis 54.

Each pivot arm 56A,B and the steering lever 40 can have, for example and without being limitative, a pivoting angle ranging from about 60° to about 80° on either side (e.g., left and right) of a zero-degree position. For the pivot arms 56A,B, the zero-degree position corresponds to a twelve o'clock position or a neutral position, i.e., the pivot arms 56A,B are in this case aligned with a longitudinal axis of the industrial vehicle). For the steering lever 40, the zero-degree position also corresponds to a twelve o'clock or a neutral position, but, in this case, in which the steering lever 40 is aligned with a vertical axis of the industrial vehicle (i.e., parallel to the force of gravity).

Returning to FIGS. 3A-C and 4, in the illustrated embodiment, the reducer assembly 50 is a one-stage reducer assembly that includes an upper sprocket 68, a lower sprocket 70 and a drive chain 72. It is to be noted that other types of one-stage reducer assemblies as well as multi-stage reducer assemblies can be used in other embodiments of the steering system 26.

In the illustrated embodiment, the upper sprocket 68 is mounted to the upper steering shaft 46 and is rotatable along with the upper steering shaft 46 about the upper steering shaft axis 52. The lower sprocket 70 is mounted to the lower steering shaft 48 and rotatable along with the lower steering shaft 48 about the lower steering shaft axis 54. The drive chain 72 engages and interconnects the upper sprocket 68 and the lower sprocket 70, to enable a transmission of the rotational movement of the upper steering shaft 46 (by the steering wheel 38) to the lower steering shaft 48.

In some implementations, the one-stage reducer steering assembly 50 could be configured or provided with mechanical components allowing to adjust the steering play and/or backlash. For example and without being limitative, such mechanical components could include slidable bearing supports associated with the lower steering shaft 48.

The reducer assembly 50 has a gearing ratio that is determined by a ratio of a number of teeth of the lower sprocket 70 to a number of teeth of the upper sprocket 68. In some implementations, the gearing ratio ranges between about 1:1 and about 10:1. In some embodiments, the gearing ratio is such that the operator can smoothly yet relatively easily turn the driving wheel 38. As such, the number of teeth of the upper sprocket 68 is generally smaller than the number of teeth of the lower sprocket 70.

In some embodiments, the gearing ratio can be 6:1. For example, and without being limitative, the number of teeth of the upper sprocket 58 could be equal to 9, while the number of teeth of the lower sprocket 60 could be equal to 54. In some embodiments, the lower sprocket 60 is made (i.e., sized and configured) to be much larger than the upper sprocket 58, to provide a high reduction ratio (i.e., a high gearing ratio). High reduction ratio could refer to, for example and without being limitative, to gearing ratio greater than 5:1. Thanks to a high-reduction ratio, and a relatively wide rotational range (i.e., wider than a common automotive steering gearbox), the steering lever 40 can be made with the effective swinging radius 66 substantially equal to the effective pivoting radii 64A,B of the pivot arms 56A,B, hence allowing a sharp turning (i.e., steering) angle, or short turning radius, with an almost constant steering effort.

In the illustrated embodiment, the reducer steering mechanism 44 is centrally positioned between the steering axes 36A,B of the steerable front wheels 24A,B. Of course, one would readily understand that the reducer steering mechanism 44 could be off-centered with respect to a center longitudinal axis of the industrial vehicle in which the steering system 26 is used, i.e., closer to one of the steerable front wheels 24A,B than to the other.

In some embodiments, the one-stage reducer steering assembly 50 is inclined forwardly and downwardly, hence enabling to incline the steering wheel 38 without the use of bevel gears or universal joints or flexible joints. Such a mechanical configuration could be useful, for example and without being limitative, for inclining the steering wheel 38 and could allow moving the steering wheel 38 further forward and downward, which in turn could allow increasing (i.e., adjusting) the driver's space 32, hence providing an ergonomic steering wheel 38 and/or a straight stand-up driving position.

Broadly, in operation, and with reference to FIGS. 3, 4 and 5A-B (i.e., the first exemplary embodiment described above), a rotational motion imparted to the steering wheel 38 is transferred to the steering lever 40 successively via the upper steering shaft 46, the upper sprocket 68, the drive chain 72, the lower sprocket 70, and the lower steering shaft 48. The rotational motion of the steering lever 40 is converted into a linear motion (along an axis transversal to the moving direction of the vehicle) of the tie rod 58 which acts to steer the front wheel 24A to which it is connected (i.e., the leading wheel) around the associated steering axis 36A. The other front wheel 24B (i.e., the trailing wheel) is also steered due to its connection to the leading wheel 24 via the track rod 60. Of course, it will be readily understood that similar operation could also be conducted with the other exemplary embodiments or variants which have been presented in the current description.

Now turning to FIGS. 3A-C, an example of the operation of the steering system and the industrial vehicle will now be described in greater detail.

In a first operation position, illustrated in FIG. 3A, the front wheels 24A,B are in a neutral position. In this neutral position, the steering wheel 38 is also at a neutral position, i.e., is not rotated in a left or right direction. As such, if the industrial vehicle 20 is operated, the industrial vehicle 20 hence moves forward along a straight direction.

In a second operation position, illustrated in FIG. 3B, the steering wheel 38 is rotated right, i.e., in a clockwise direction, and so the front wheels 24A,B are steered in the same direction, by the action of the tie rod 58 and the track rod 60 on the pivot arms 56A,B, which effect a push-pull motion in response to the driver's input through the steering wheel 38. If the industrial vehicle 20 is operated, the industrial vehicle 20 turns left, following a turning radius.

In a third operation position, illustrated in FIG. 3C, the steering wheel 38 is rotated left, i.e., in a counterclockwise direction, and so the front wheels 24A,B are steered in the same direction. If the industrial vehicle 20 is operated, the industrial vehicle 20 turns right, following a turning radius.

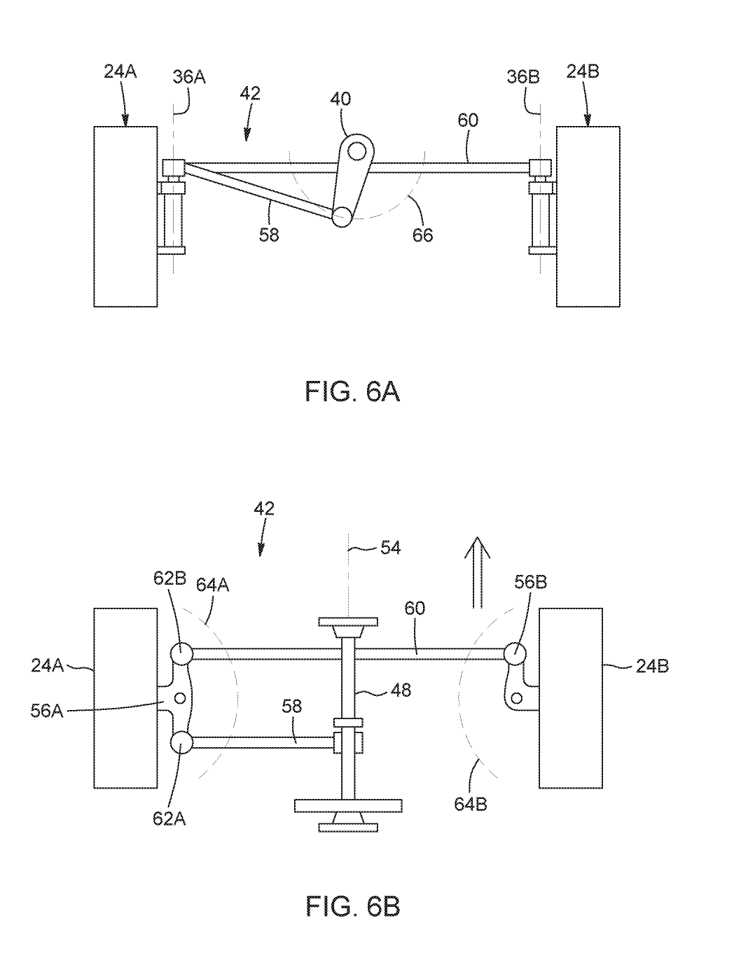

Now turning to FIGS. 6A-B a second exemplary embodiment of the steering system 26 will now be described.

The second exemplary embodiment is similar to the first exemplary embodiment described above with reference to FIGS. 3,4 and 5A-B in that it also includes a reducer steering mechanism 44 having a rotatable steering wheel 38, an upper steering shaft 46, a lower steering shaft 48, a reducer assembly 50 and a steering lever 40, as well as a steering linkage 42. Moreover, the mechanical relationships between these components remain substantially the same.

Despite those similarities, the second exemplary embodiment mostly differs from the first exemplary embodiment in term of the positioning of the tie rod 58 and the track rod 60 with respect to the steering axis 36A of the leading wheel 24A.

More particularly, and as depicted in FIGS. 6A-B, in this embodiment, the tie rod 58 is secured to the leading pivot arm 56A at a first location 62A and the track rod 60 is secured to the leading pivot arm 56A at a second location thereof 62B, such that the first location 62A and the second location 62B are located on either side of the steering axis 36A of the leading wheel 24A. More particularly, the tie rod 58 and the track rod 60 are located respectively behind and in front of the steering axis 36A of the leading wheel 24A with respect to the forward moving direction (defined by the upwardly directed arrow in FIG. 6B).

In some embodiments, the first and second locations 62A,B are each positioned at a respective first and second distance from the steering axis 36A. While the respective first and second distances could be equal (i.e., the first and second locations 62A,B are diametrically opposed with respect to the steering axis 36A), one skilled in the art would recognize that the first and second distances could be different from one another.

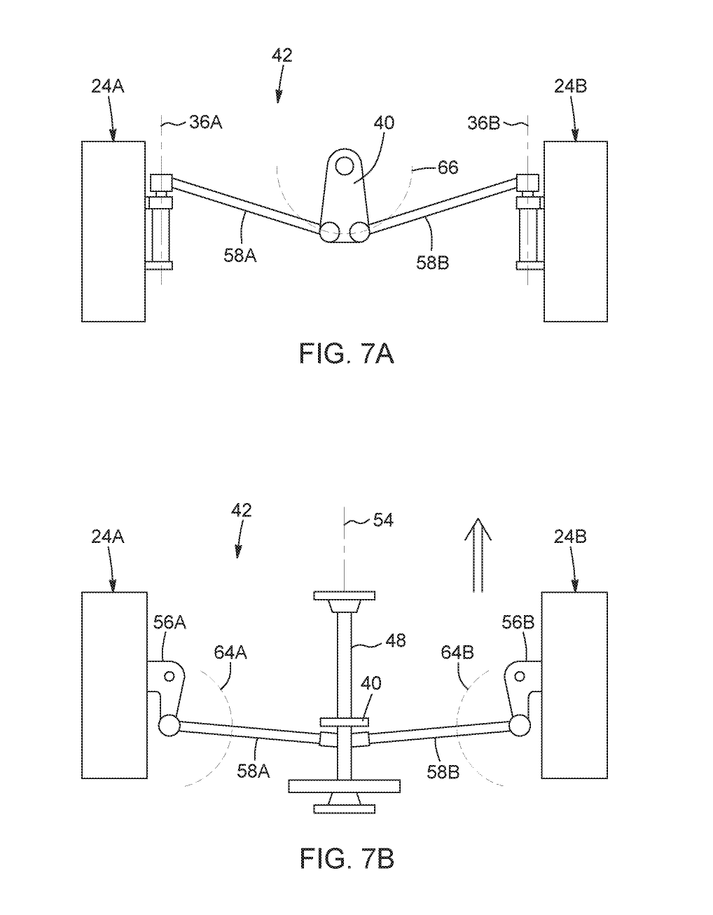

Now turning to FIGS. 7A-B, a third exemplary embodiment of the steering system 26 is shown. While this third exemplary embodiment share some common features with the first and second exemplary embodiments presented above, it also differs therefrom in the structure and configuration of its steering linkage 42, as will now be described. Again, the upwardly directed arrow in FIGS. 7A-7B defines the forward moving direction of the industrial vehicle provided with the steering system 26.

The steering linkage 42 in the third embodiment still includes a pair of pivot arms 56A,B, but further includes a pair of tie rods 58A,B, rather than one tie rod and one track rod as in the first and second embodiments. More specifically, each pivot arm 56A,B is coupled to a respective one of the pair of steerable front wheels 24A,B and pivotable therewith about the respective steering axis 36A,B. Each tie rod 58A,B is pivotally coupled between the steering lever 40 and a respective one of the pair of pivot arms 56A,B, and laterally movable by the swinging motion of the steering lever 40 to turn, via the respective pivot arm 56A,B, the respective steerable front wheel 24A,B about the corresponding steering axis 36A,B.

Now that various exemplary embodiments of the steering system have been described, the mechanical connection between the steering system and the industrial vehicle will now be described in greater detail.

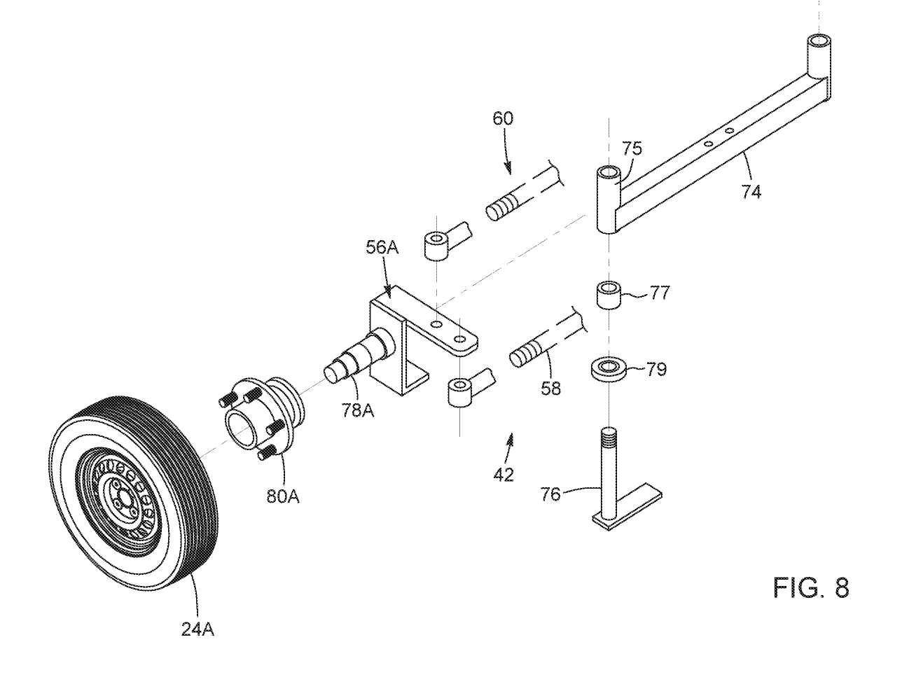

More particularly, turning to FIG. 8, a partially exploded perspective view illustrating the connection between the steering linkage 42 of a steering system 26 and a leading front wheel 24A of industrial vehicle. The steering system 26 in FIG. 8 is similar to that depicted in FIGS. 3, 4 and 5A-B in that the tie rod 58 is attached to the leading pivot arm 56A closer to the steering axis 36A.

In the depicted embodiment, there is shown a front axle 74. The front axle 74 mounted to the frame of the industrial vehicle. The leading pivot arm 56A is pivotally coupled to the front axle 74 for rotation about the steering axis 36A of the leading front wheel 24A. The front axle 74 includes vertical tubular sleeves 75 at the ends thereof, each one of the vertical tubular sleeve 75 extending along a respective one of the steering axes 36A,B. The leading pivot arm 56A is rigidly connected to a pivot shaft 76 that is coaxially inserted into one of the tubular sleeves 75 for rotation thereinside about the steering axis 36A of the leading wheel 24A. For example, the leading pivot arm 56A may be rotatably coupled to the tubular sleeve via rotary bearings (e.g., bush bearing 77 and thrust bearing 79). Of course, various mechanical components such as bolts, screws, threaded shafts, bearings, bushings and the like could be used to enable the mechanical coupling between the leading pivot 56A and the front axle 74.

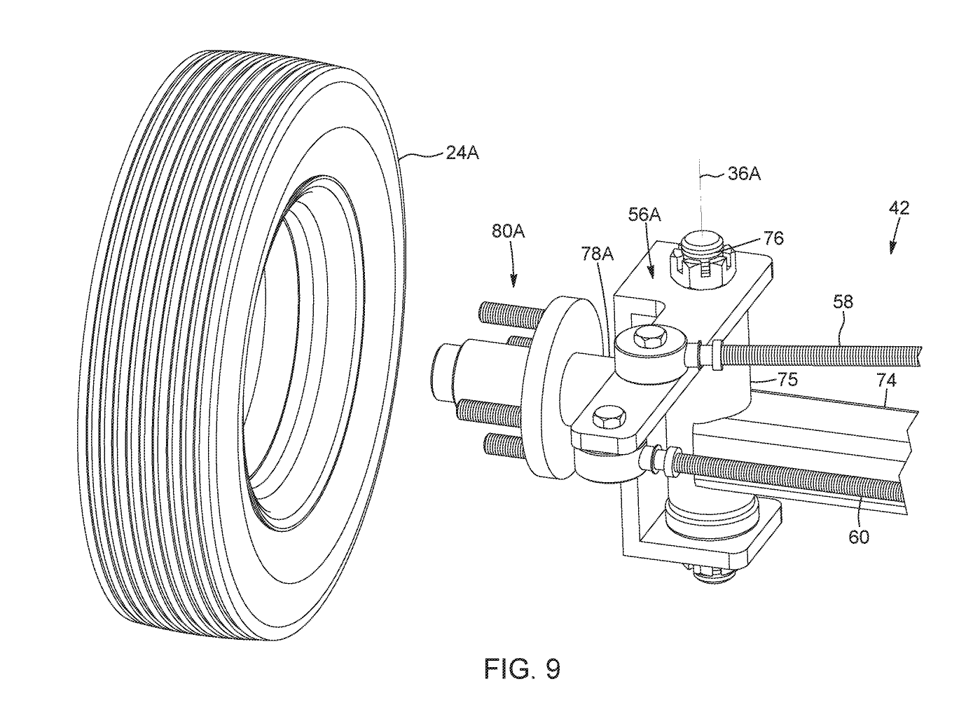

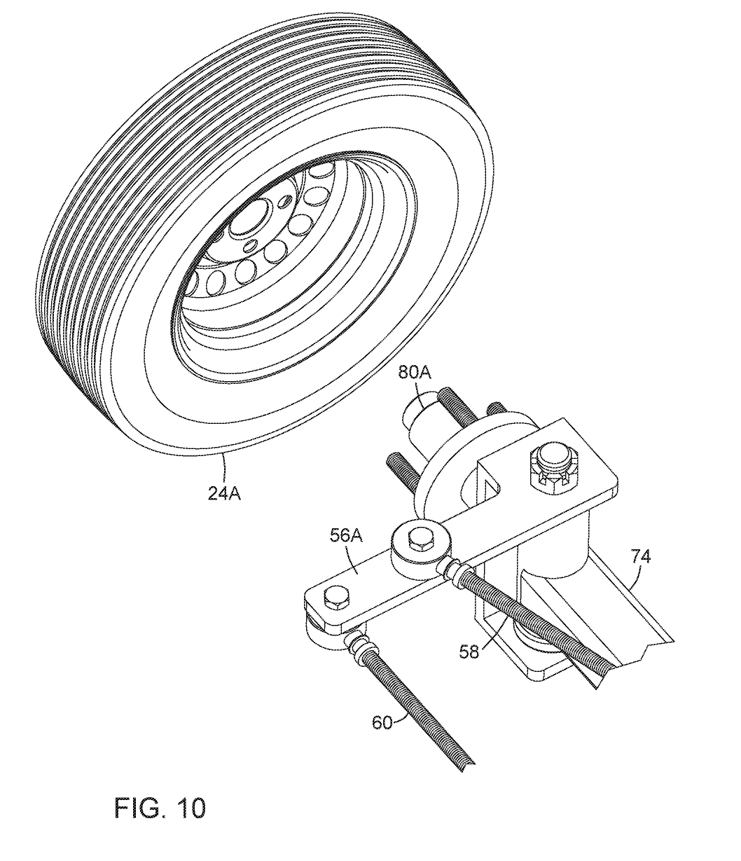

With reference to FIGS. 9 and 10, a stub axle 78A projects from the pivot arms 56A. The stub axle 78A is sized and configured to support, i.e., carry a wheel hub 80A of a corresponding wheels 24A. The wheel hub 80A can be mounted to the stub axle 78A using know components and pieces, such as, but not limited to, oil seal and bearing. The front wheel 24A can be mounted to the wheel hub 80A using known mechanical components and pieces, such as nut, bearing, bolts, and the like. In some embodiments, the wheel hub 80A is provided with a dust cap. While not expressly illustrated in FIGS. 9 and 10, one would understand that the other pivot arm, see for example the pivot arm 56B of FIGS. 5A-B, could also project from a corresponding stub axle configured to support a respective wheel hub.

As illustrated in FIG. 9, the leading pivot arm 36A includes a respective radially extending portion. The respective radially extending portion projects outwardly from the corresponding steering pivot axes 36A. Moreover, the track rod 60 is pivotally coupled to the respectively radially extending portion of each of the leading pivot arm 36A and the trailing pivot arm (not shown in FIG. 9, but visible in FIGS. 5A-B, for example), as it has been previously described. Similar features can also be encountered with the other pivot arm, for example and without being limitative, the trailing pivot arm 36B illustrated in FIGS. 5A-B.

The various exemplary embodiments of the steering system described above could, in some scenarios, be less expensive to produce than conventional steering systems with multi-stage reducer steering mechanisms. These cost savings can be used to build the steering system with components and parts of better quality. Moreover, the relatively low cost associated with some embodiments of the steering system disclosed herein notably comes from the fact that the steering system require neither components such as bevels, worms, racks and pinions, or spur gears, nor high-precision parts or power assist. As it has been previously discussed, some embodiments may allow for an efficient backlash adjustment and provide a precise and responsive steering control.

Stand-Up Type Industrial Vehicle with Dual-Pivot Steering System

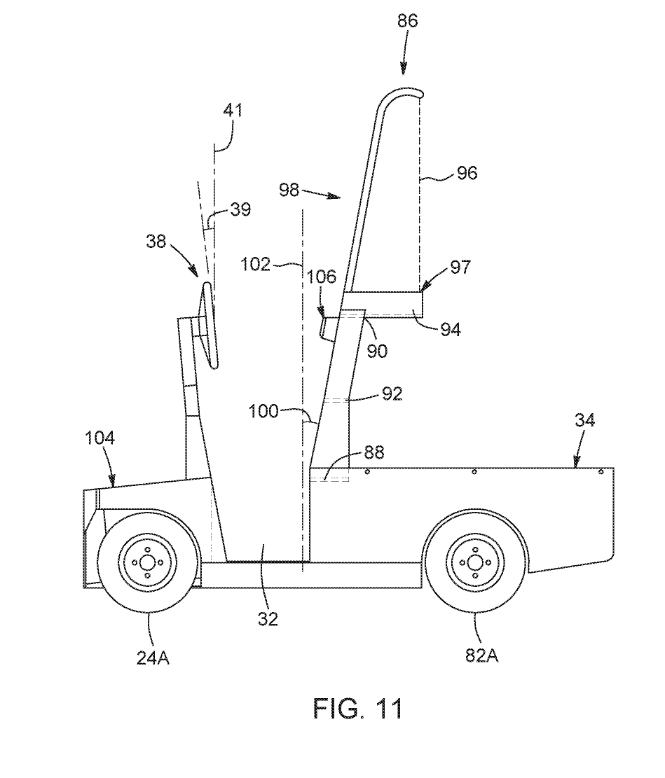

Returning to FIGS. 2A-B, and referring also to FIG. 11, the stand-up type industrial vehicle 20 includes a frame 22, a pair of steerable front wheels 24A,B and a steering system 26.

The frame 22 extends between a front end 28 and a rear end 30 and includes a driver's space 32 for accommodating the operator. The pair of steerable front wheels 24A,B is coupled to the frame 22, and can be steered using the different embodiments and variants of the steering system 26 which have been previously presented in the current description. Broadly described, the industrial vehicle 20 disclosed includes a dual-pivot steering system 26 including a one-stage reducer steering mechanism that can steer both steering pivots using a vertical or nearly vertical steering wheel 38 (see for example the tilt angle 39 with respect with the vertical steering axis 41 of the steering wheel 38).

In some embodiments, the industrial vehicle includes 20 a pair of rear wheels 82A,B coupled to the frame 22. The frame 22 may be provided with a front axle 74. The front axle is mounted transversely to the frame 22 to support the pair of steerable front wheels 36A,B. In these embodiments, the industrial vehicle can also include a rear axle 84 mounted transversely to the frame 22 to support the pair of rear wheels 82A,B.

In some embodiments, the driver's space 32 is provided between the front axle 74 and the rear axle 84. The driver's space 32 can be provided closer to the front end 28 than the rear end 30, or vice-versa. In some implementations, the driver's space 32 is at a midpoint between the front end and the rear end 30. Such driver's space 34 may be useful, for example, to reduce vibrations from floor imperfections and to allow for a user to stand in a straight driving position.

The driver's space 32 of the illustrated embodiment may have substantially larger dimensions (e.g., in length and/or in width) compared to those of conventional industrial vehicles of the prior art. These larger dimensions may facilitate, for example, getting in and out of the industrial vehicle, while maintaining the good stability of the industrial vehicle.

The industrial vehicle 20 also includes a cargo space 34. The cargo space 34 extends rearwardly of the driver's space 32. In some embodiments, the cargo space 34 has a loading surface area ranging between about 1200 and about 1800 square inches. While the cargo space 34 is illustrated as having a substantially flat surface with a relatively rectangular shape, one will readily understand that the cargo space 34 could have any shape and/or dimensions, as long as it allows supporting products or material on its surface.

In some embodiments, the cargo space 34 has a 1000-lbs cargo capacity or more, and may meet any other industry standards. It will be readily understood that the cargo space 34 can be embodied by any deck, platform, surface or support structure onto which products can be loaded, supported and/or transported. In some implementations, the industrial vehicle 20 can additionally, or alternatively, include a front-loading space 104 located forwardly of the driver's space 32 and on which products can be loaded.

Referring still to FIGS. 2A-B, the industrial vehicle 20 also includes a ladder 76 extending upwardly and rearwardly between a lower end 88 mounted to the frame 22, adjacent to and behind the driver's space 32, and an upper end 90. In some variants, the ladder 86 is bolted or welded at or near the lower end 88 onto the frame 22. The ladder 86 can have a relatively smooth inclination/angle, such that the ladder 86 is easy to climb. Alternatively, the ladder 86 can be integral to the frame 22. In some variants, the ladder 86 is extendable or telescopic.

In some embodiments, the lower end 88 of the ladder 86 is mounted to the frame 22 at substantially a midpoint between the front end 28 and the rear end 30 of the frame 26.

The ladder 86 includes one or more rungs 92 such that the operator can climb the ladder 86. In some embodiments, the ladder 92 includes between one and five rungs. The number of rungs 92 can vary according to the working height, which may vary according to the targeted application.

Referring to FIG. 11, in another embodiment, the industrial vehicle 20 includes a cantilever platform 94 extending rearwardly from the upper end 90 of the ladder 86 and configured for the operator to stand thereon. For example, the cantilever platform 94 can have a platform surface area ranging from about 200 square inches to 500 square inches, although other dimensions can be used in other implementations.

As previously mentioned, the cantilever platform 94 may be positioned at various working heights, depending on the application. For example, in some embodiments, the cantilever platform 94 is positioned at a working height of about 48 inches above ground.

In some embodiments, the cantilever platform 94 includes a guard rail 96 extending upwardly along a perimeter 97 thereof. The guard rail 96 has a front opening 98 to allow access between the cantilever platform 94 and the ladder 86.

In some embodiments, the ladder 86 can be inclined at an inclination angle 100 ranging between about 8° and about 15° with respect to a vertical axis 102. Such inclination angle may facilitate climbing and descending the ladder 86. The ladder 86 can allow a user to reach materials or products placed in high-locations, and so could be embodied by a broad variety of structures or elements allowing to safely reach tall objects or high shelves. Of course, values of inclination angle outside of this range can be used in other implementations

In some embodiments, the ladder 86, and the rungs 96, have a lateral extent ranging from about 25 inches to about 35 inches. In some variants, the lateral extent of the ladder 86 is substantially equal to a lateral extent of the frame 22. Of course, other dimensions can be used in other embodiments.

In some embodiments, the industrial vehicle 20 includes a backrest cushion 106 mounted on the ladder 86. Such backrest cushion 106 may be useful for providing support to the body of the operator, for example his or her back. In some scenarios, the ladder 86 may be replaced by a structural member, or a bulkhead, on which can be mounted the backrest cushion 106 and/or the ladder 86.

As described in the current description, the various embodiments of the industrial vehicle may allow a safer operation and reduce or at least reduce tip-over hazards. Furthermore, the industrial vehicle may allow to solve or at least reduce some of the previously identified drawbacks by providing an industrial vehicle which would: allow reducing vibrations induced by floor imperfections (hence reducing back pain problems); provide a more ergonomic driving position; allow reducing user's fatigue; provide an easier-to-climb, smooth-angle ladder; provide an ergonomic and more easily maneuverable steering wheel; provide a precise steering control and efficient backlash adjustment; and/or provide a low manufacturing costs steering system. In addition, the dual-pivot steering system with a one-stage reducer steering mechanism can allow the user to provide a constant steering effort over a wide range of rotation angles, and provides good maneuverability, a short turning radius and a sharp steering pivot angle.

Some implementations provide a stock chaser with increased lateral, as well as longitudinal stability to reduce tip-over hazards and associated risks. Other implementations provide a stock chaser that is configured to allow an operator to operate the stock chaser in an ergonomic standing position, without affecting the stability of the stock chaser. Some embodiments of the stock chaser may be provided with a driver's space that is not mounted to the frame in a cantilever configuration, to reduce vibrations. Some variants of the stock chaser provide a stock chaser that may be made with a ladder having a rather smooth inclination (contrary to a “steep ladder”) to facilitate stock picking of products located in hard-to-reach areas.

Now turning back to FIG. 2B, some advantageous aspects of the industrial vehicle herein described will be further described. FIG. 2B is a top plan view of the industrial vehicle 20, depicting its two steering axes 36A,B (dual-pivot steering), center of gravity 108 and two tip-over axes 110A,B. The tip over axes 110A,B extend between the front end 28 and the rear end 30 of the frame 22, along the left side (determined by the front and rear left wheels 36A, 82A) and the right side (determined by the front and rear right wheels 36B, 82B) of the industrial vehicle 20, respectively, which is in contrast with the conventional vehicle illustrated in FIGS. 1A-B (PRIOR ART). In this regard, the dual-pivot steering system described herein may overcome or at least reduce stability problems and issues associated with conventional stand-up type industrial vehicles, and may further provide industrial vehicles with a driver's space that does not increase tip-over hazards.

Several alternative embodiments and examples have been described and illustrated herein. The embodiments of the invention described above are intended to be exemplary only. A person skilled in the art would appreciate the features of the individual embodiments, and the possible combinations and variations of the components. A person skilled in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while specific embodiments have been illustrated and described, numerous modifications come to mind without significantly departing from the scope of the invention as defined in the appended claims.

1. A steering system for use in a stand-up type industrial vehicle having a pair of steerable front wheels, each steerable front wheel being pivotable about a respective one of a pair of steering axes, the steering system comprising:
a reducer steering mechanism comprising:
a rotatable steering wheel;
an upper steering shaft rotatable about an upper shaft axis by the steering wheel;
a lower steering shaft coupled to the upper steering shaft and rotatable therewith about a lower shaft axis;
a reducer assembly coupled between the upper steering shaft and the lower steering shaft to rotate the lower steering shaft upon rotation of the upper steering shaft; and
a steering lever extending outwardly from the lower steering shaft and effecting a swinging motion about the lower shaft axis upon rotation of the lower steering shaft; and
a steering linkage operatively connected between the steering lever and the steerable wheels, the steering linkage being configured to translate the swinging motion of the steering lever into a turning motion of the steerable front wheels about the steering axes thereof.

2. The steering system of claim 1, wherein the pair of steerable front wheels defines a leading wheel and a trailing wheel, and the steering linkage comprises:
a pair of pivot arms defining a leading pivot arm coupled to the leading wheel and pivotable therewith about the steering axis thereof, and a trailing pivot arm coupled to the trailing wheel and pivotable therewith about the steering axis thereof;
a tie rod pivotally coupled between the steering lever and the leading pivot arm, the tie rod being laterally movable by the swinging motion of the steering lever to turn, via the leading pivot arm, the leading wheel about the steering axis thereof; and
a track rod pivotally coupled between the leading pivot arm and the trailing pivot arm to cause the trailing wheel to turn about the steering axis thereof upon turning of the leading wheel.

3. The steering system of claim 2, wherein the tie rod is secured to the leading pivot arm at a first location thereof, and the track rod is secured to the leading pivot arm at a second location thereof, the second location being farther remote from the steering axis of the leading wheel than is the first location.

4. The steering system of claim 2, wherein the tie rod is secured to the leading pivot arm at a first location thereof and the track rod is secured to the leading pivot arm at a second location thereof, the first location and the second location being located on either side of the steering axis of the leading wheel.

5. The steering system of claim 1, wherein the steering linkage comprises:
a pair of pivot arms, each pivot arm being coupled to a respective one of the pair of steerable front wheels and pivotable therewith about the steering axis thereof; and
a pair of tie rods, each tie rod being pivotally coupled between the steering lever and a respective one of the pair of pivot arms, and laterally movable by the swinging motion of the steering lever to turn, via the respective pivot arm, the respective steerable front wheel about the corresponding steering axis thereof.

6. The steering system of claim 1, wherein the reducer assembly is a one-stage reducer assembly comprising:
an upper sprocket mounted to the upper steering shaft and rotatable therewith about the upper steering shaft axis;
a lower sprocket mounted to the lower steering shaft and rotatable therewith about the lower steering shaft axis; and
a drive chain engaging and interconnecting the upper sprocket and the lower sprocket to transmit, in one stage, the rotation of the upper steering shaft to the lower steering shaft.

7. An industrial vehicle comprising:
a frame extending between a front end and a rear end, the frame comprising a driver's space for accommodating an operator;
a pair of steerable front wheels coupled to the frame, each steerable front wheel being pivotable relative to the frame about a respective one of a pair of laterally spaced-apart steering axes; and
a steering system mounted to the frame for steering the pair of steerable front wheels, comprising:
a reducer steering mechanism comprising:
a steering wheel rotatable by the operator;
an upper steering shaft rotatable about an upper shaft axis by the steering wheel;
a lower steering shaft coupled to the upper steering shaft and rotatable therewith about a lower shaft axis;
a reducer assembly coupled between the upper steering shaft and the lower steering shaft to rotate the lower steering shaft upon rotation of the upper steering shaft; and
a steering lever extending outwardly from the lower steering shaft and effecting a swinging motion about the lower shaft axis upon rotation of the lower steering shaft; and
a steering linkage operatively connected between the steering lever and the steerable front wheels, the steering linkage being configured to translate the swinging motion of the steering lever into a turning motion of the steerable front wheels about the steering axes thereof.

8. The industrial vehicle of claim 7, further comprising:
a pair of rear wheels coupled to the frame;
a front axle mounted transversally to the frame and supporting the pair of steerable front wheels; and
a rear axle mounted transversally to the frame and supporting the pair of rear wheels,
wherein the driver's space is provided between the front axle and the rear axle.

9. The industrial vehicle of claim 7, further comprising a cargo space extending rearwardly of the driver's space.

10. The industrial vehicle of claim 7, further comprising a ladder extending upwardly and rearwardly between a lower end mounted to the frame, adjacent to and behind the driver's space, and an upper end.

11. The industrial vehicle of claim 10, wherein the lower end of the ladder is mounted to the frame at substantially a midpoint between the front end and the rear end of the frame.

12. The industrial vehicle of claim 10, further comprising a cantilever platform extending rearwardly from the upper end of the ladder and configured for the operator to stand thereon.

13. The industrial vehicle of 12, wherein the cantilever platform comprises a guard rail extending upwardly along a perimeter thereof, the guard rail having a front opening to allow access between the cantilever platform and the ladder.

14. The industrial vehicle of claim 10, wherein the ladder is inclined at an inclination angle ranging between about 8° and about 15° with respect to a vertical axis.

15. The industrial vehicle of claim 7, wherein the pair of steerable front wheels defines a leading wheel and a trailing wheel, and the steering linkage comprises:
a pair of pivot arms defining a leading pivot arm coupled to the leading wheel and pivotable therewith about the steering axis thereof, and a trailing pivot arm coupled to the trailing wheel and pivotable therewith about the steering axis thereof;
a tie rod pivotally coupled between the steering lever and the leading pivot arm, the tie rod being laterally movable by the swinging motion of the steering lever to turn, via the leading pivot arm, the leading wheel about the steering axis thereof; and
a track rod pivotally coupled between the leading pivot arm and the trailing pivot arm to cause the trailing wheel to turn about the steering axis thereof upon turning of the leading wheel.

16. The industrial vehicle of claim 15, wherein the tie rod is secured to the leading pivot arm at a first location thereof, and the track rod is secured to the leading pivot arm at a second location thereof, the second location being farther remote from the steering axis of the leading wheel than is the first location.

17. The industrial vehicle of claim 15, wherein the tie rod is secured to the leading pivot arm at a first location thereof and the track rod is secured to the leading pivot arm at a second location thereof, the first location and the second location being located on either side of the steering axis of the leading wheel.

18. The industrial vehicle of claim 7, wherein the steering linkage comprises:
a pair of pivot arms, each pivot arm being coupled to a respective one of the pair of steerable front wheels and pivotable therewith about the steering axis thereof; and
a pair of tie rods, each tie rod being pivotally coupled between the steering lever and a respective one of the pair of pivot arms, and laterally movable by the swinging motion of the steering lever to turn, via the respective pivot arm, the respective steerable front wheel about the corresponding steering axis thereof.

19. The industrial vehicle of claim 7, wherein the reducer assembly is a one-stage reducer assembly comprising:
an upper sprocket mounted to the upper steering shaft and rotatable therewith about the upper steering shaft axis;
a lower sprocket mounted to the lower steering shaft and rotatable therewith about the lower steering shaft axis; and
a drive chain engaging and interconnecting the upper sprocket and the lower sprocket to transmit the rotation of the upper steering shaft to the lower steering shaft.

20. The industrial vehicle of claim 7, wherein the steering wheel is tilted forwardly and downwardly at a tilt angle ranging from about 0° to about 15°.

21. An industrial vehicle comprising:
a frame extending between a front end and a rear end, the frame comprising a driver's space for accommodating an operator and a cargo space behind the driver's space;
a pair of steerable front wheels pivotally coupled to the frame about a respective pair of laterally spaced-apart steering axes; and
a steering system mounted to the frame for steering the pair of steerable front wheels, comprising a steering wheel rotatable by the operator, a steering lever operatively coupled to the steering wheel to be imparted a lateral swinging motion thereby upon rotation thereof, a steering linkage operatively coupled between the steering lever and the steerable front wheels to translate the lateral swinging motion of the steering lever into a turning motion of the steerable front wheels about the steering axes thereof.

22. The industrial vehicle of claim 21, comprising a one-stage reducer interconnecting the steering wheel and the steering level.

23. The industrial vehicle of claim 21, further comprising a ladder extending upwardly and rearwardly between a lower end mounted to the frame, adjacent to and behind the driver's space, and an upper end.

24. The industrial vehicle of claim 21, further comprising a cantilever platform extending rearwardly from the upper end of the ladder above the cargo area.
